(19) United States
(12) Patent Application Publication
(10) Pub. No.: US 2026/0148135 A1
(43) Pub. Date: May 28, 2026

(54) METHOD AND DEVICE FOR GRAY-BOX ADVERSARIAL ATTACK ON LEARNING MODEL

(71) Applicant: POSTECH RESEARCH AND BUSINESS DEVELOPMENT FOUNDATION, Pohang-si (KR)

(72) Inventors: Young Joo SUH, Pohang-si (KR); Suha KWAK, Pohang-si (KR); Junhyung JO, Pohang-si (KR); Joong Su KIM, Pohang-si (KR)

(21) Appl. No.: 19/177,867

(22) Filed: Apr. 14, 2025

(30) Foreign Application Priority Data
Apr. 12, 2024 (KR) 10-2024-0049101

(51) Int. Cl. G06N 20/00

(52) U.S. Cl. CPC G06N 20/00

(57) ABSTRACT

The present disclosure relates to a method and device for a gray-box adversarial attack on a learning model, and more specifically to a method and device for performing a gray-box adversarial attack on a learning model generated by semi-supervised learning. According to an embodiment, a method for attacking a main model, performed by a computing device may include: training an attack model using shared labeled data; performing an attack on the attack model to generate an adversarial example; and inputting the adversarial example to the main model to induce an inference about the adversarial example.

### CROSS REFERENCE TO RELATED APPLICATION

The present application claims priority to and the benefit of Korean Patent Application No. 10-2024-0049101, filed on Apr. 12, 2024, the disclosure of which is incorporated herein by reference in its entirety.

### TECHNICAL FIELD

The present disclosure relates to a method and device for a gray-box adversarial attack on a learning model, and more specifically to a method and device for performing a gray-box adversarial attack on a learning model generated by semi-supervised learning.

### BACKGROUND

Machine learning refers to a process in which a machine learns based on data to perform a specific task, and may be classified into supervised learning, unsupervised learning, and semi-supervised learning according to kinds of data used in learning. The supervised learning is performed using only labeled data, and unsupervised learning is performed using only unlabeled data. Further, semi-supervised learning is performed using both labeled data and unlabeled data.

Meanwhile, with the development of machine learning, various studies are being conducted on adversarial attacks on a learning model generated through the machine learning. The adversarial attack refers to intentionally injecting malicious learning data to degrade the performance of the learning model, or generating an adversarial example and inputting it into the learning model to induce incorrect inference.

Along with the development of machine learning, the adversarial attack techniques have also been also developed. Therefore, it is necessary to identify the vulnerabilities of the learning model and increase the robustness of the learning model against various adversarial attack techniques. To this end, new adversarial attack techniques applicable to the respective learning models are required to be researched and analyzed. However, only the adversarial attack techniques for the learning model generated by the supervised learning have conventionally been studied, and in particular, studies on adversarial attack techniques for the learning model generated by the semi-supervised learning are insufficient.

### SUMMARY

The objective of the present disclosure is to provide a gray-box adversarial attack method and apparatus as a new attack technique on a learning model generated by semi-supervised learning.

The objective of the present disclosure is not limited to the above-mentioned objective, and other s and advantages of the present disclosure that are not mentioned will be more clearly understood by the following embodiments of the present disclosure. Further, the aspects and advantages of the present disclosure will be realized by the components and combinations thereof disclosed in the claims.

According to an embodiment, a method for attacking a main model, performed by a computing device may include: training an attack model using shared labeled data; performing an attack on the attack model to generate an adversarial example; and inputting the adversarial example to the main model to induce an inference about the adversarial example.

According to an embodiment, the main model may be generated by semi-supervised learning performed using the shared labeled data.

According to an embodiment, the main model may be trained using pseudo-labeled data and the shared labeled data.

According to an embodiment, the number of pseudo-labeled data may be greater than the number of the shared labeled data.

According to an embodiment, the pseudo-labeled data may be generated by an auxiliary model trained using the shared labeled data.

According to an embodiment, the auxiliary model may perform pseudo-labeling for unlabeled data to generate the pseudo-labeled data.

According to an embodiment, the number of the unlabeled data may be greater than the number of the shared labeled data.

According to an embodiment, a computing device for attacking a main mode may include at least one processor; and a memory. The at least one processor may train an attack model using shared labeled data; perform an attack on the attack model to generate an adversarial example; and input the adversarial example to the main model to induce an inference about the adversarial example.

According to an embodiment, the main model may be generated by semi-supervised learning performed using the shared labeled data.

According to an embodiment, the main model may be trained using pseudo-labeled data and the shared labeled data.

According to an embodiment, the number of pseudo-labeled data may be greater than the number of the shared labeled data.

According to an embodiment, the pseudo-labeled data may be generated by an auxiliary model trained using the shared labeled data.

According to an embodiment, the auxiliary model may perform pseudo-labeling for unlabeled data to generate the pseudo-labeled data.

According to an embodiment, the number of the unlabeled data may be greater than the number of the shared labeled data.

According to an embodiment, a computer program stored in a computer-readable storage medium may perform operations to train a language model upon being executed in one or more processors, and the operations may include: training an attack model using shared labeled data; performing an attack on the attack model to generate an adversarial example; and inputting the adversarial example to the main model to induce an inference about the adversarial example.

According to an embodiment, the main model may be generated by semi-supervised learning performed using the shared labeled data.

According to an embodiment, the main model may be trained using pseudo-labeled data and the shared labeled data.

According to an embodiment, the number of pseudo-labeled data may be greater than the number of the shared labeled data.

According to an embodiment, the pseudo-labeled data is generated by an auxiliary model trained using the shared labeled data.

According to an embodiment, the auxiliary model may perform pseudo-labeling for unlabeled data to generate the pseudo-labeled data.

According to an embodiment, the number of the unlabeled data may be greater than the number of the shared labeled data.

### BRIEF DESCRIPTION OF DRAWINGS

FIG. 1 is a block diagram of a computing device that performs a method for attacking a learning model according to an embodiment.

FIG. 2 is a schematic diagram showing a network function according to an embodiment.

FIG. 3 is a schematic diagram showing a process of generating a main model according to an embodiment and a process of attacking the main model.

FIG. 4 is a flowchart of a method for attacking a main model according to an embodiment.

FIG. 5 is a simple and general schematic diagram for an exemplary computing environment where embodiments of the present disclosure can be implemented.

### DETAILED DESCRIPTION

The foregoing purposes, features, and advantages of the present disclosure will be described in detail in conjunction with the accompanying drawings, and accordingly, those skilled in the art to which the present disclosure pertains will easily implement the embodiments of the present disclosure. In describing the present disclosure, if a detailed description for a related known art is considered to unnecessarily divert the gist of the present disclosure, such description will be omitted. Hereinafter, the embodiments of the present disclosure will now be described with reference to the accompanying drawings, in which like numbers refer to like elements throughout the accompanying drawings.

Hereinafter, various exemplary embodiments are described with reference to the drawings. In the present disclosure, various descriptions are presented for understanding the present disclosure. However, it is obvious that the exemplary embodiments may be carried out even without a particular description.

Terms, “component”, “module”, “system”, and the like used in the present disclosure indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and the computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present disclosure shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present disclosure and the claims.

In addition, the term “at least one of A or B” should be interpreted to mean “a case including only A,” “a case including only B,” and “a case in which A and B are combined.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description the presented exemplary about embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Accordingly, the scope of the present disclosure is not limited to the exemplary embodiments presented herein. The scope of the present disclosure shall be interpreted within the broadest meaning range consistent to the principles and new characteristics presented herein.

In the present disclosure, a network function, an artificial neural network, and a neural network may be interchangeably used.

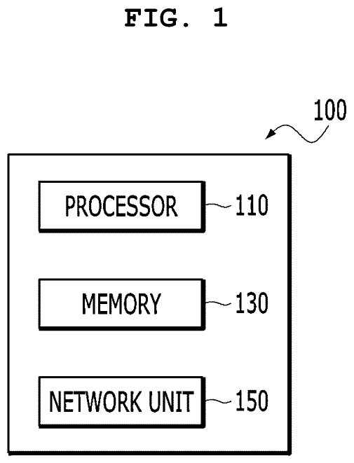

FIG. 1 is a block diagram of a computing device for training a voice recognition model according to an embodiment of the disclosure.

The configuration of a computing device 100 illustrated in FIG. 1 is only an example simplified and illustrated. In an exemplary embodiment of the present disclosure, the computing device 100 may include other components for performing a computing environment of the computing device 100, and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general-purpose graphics processing unit (GPGPU), a tensor processing unit (TPU), etc., of the computing device. The processor 110 may read a computer program stored in the memory 130 and process data for machine learning according to an embodiment of the present disclosure. According to an embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process learning of the network function. For example, the CPU and the GPGPU may process the learning of the network function and data classification using the network function jointly. In addition, in an embodiment of the present disclosure, the learning of the network function and the data classification using the network function may be processed by using processors of a plurality of computing devices together. In addition, the computer program performed by the computing device according to an embodiment of the present disclosure may be a CPU, GPGPU, or TPU executable program.

According to an embodiment, the processor 110 may train an attack model using shared labeled data. The processor 110 may generate an adversarial example by performing an attack on the attack model. The processor 110 may input the adversarial example to a main model to induce inference for the adversarial example.

According to an embodiment, the main model may be generated by the semi-supervised learning performed using the shared labeled data.

According to an embodiment, the main model may be trained using pseudo-labeled data and the shared labeled data.

According to an embodiment, the number of the pseudo-labeled data may be greater than the number of the shared labeled data.

According to an embodiment, the pseudo-labeled data may be generated by an auxiliary model trained using the shared labeled data.

According to an embodiment, the auxiliary model may perform pseudo-labeling for the unlabeled data to generate the pseudo-labeled data.

According to an embodiment, the number of the unlabeled data may be greater than the number of the shared labeled data.

According to an embodiment of the present disclosure, the memory 130 may store any type of information generated or determined by the processor 110 and any type of information received by the network unit 150.

According to an embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing may operate in connection with a web storage performing a storing function of the memory 130 on the Internet. The description of the memory is just an example and the present disclosure is not limited thereto.

According to an embodiment of the present disclosure, the network unit 150 may use various wired communication systems, such as a public switched telephone network (PSTN), an x digital subscriber line (xDSL), a rate adaptive DSL (RADSL), multi rate DSL (MDSL), a very high-speed DSL (VDSL), a universal asymmetric DSL (UADSL), a high bit rate DSL (HDSL), and a local area network (LAN).

Further, the network unit 150 presented in the present disclosure may use various wireless communication systems, such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 150 may be configured regardless of communication types, such as a wired type and a wireless type, and may be configured by various communication networks, such as a personal area network (PAN) and a wide area network (WAN). Further, the network unit 150 may be a publicly known world wide web (WWW), and may also use a wireless transmission technology used in short range communication, such as infrared data association (IrDA) or Bluetooth.

The technologies described in the present disclosure may also be used in other networks, as well as the foregoing networks.

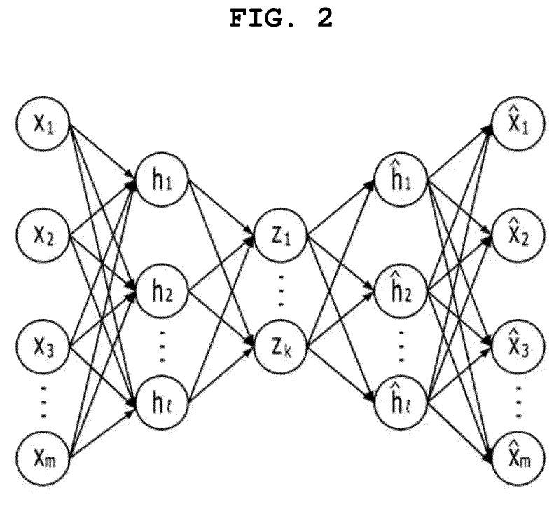

FIG. 2 is a schematic diagram showing a network function according to an embodiment of the present disclosure.

Throughout the present disclosure, an operation model, a network function, and a neural network may be used to have the same meaning. The neural network may generally be configured by a set of interconnected calculating units which may be referred to as “nodes”. The “nodes” may also be referred to as “neurons”. The neural network is configured to include at least one node. The nodes (or neurons) which configure the neural networks may be connected to each other by one or more “links”.

In the neural network, one or more nodes connected through the link may relatively form a relation of an input node and an output node. Concepts of the input node and the output node are relative so that an arbitrary node which serves as an output node for one node may also serve as an input node for the other node and vice versa. As described above, an input node to output node relationship may be created with respect to the link. One or more output nodes may be connected to one input node through the link, and vice versa.

In the input node and output node relationship connected through one link, a data value of the output node may be determined based on data input to the input node. The node which connects the input node and the output node to each other may have a weight. The weight may be variable and may vary by the user or the algorithm to allow the neural network to perform a desired function. For example, when one or more input nodes are connected to one output node by each link, the output node may determine an output node value based on values input to the input nodes connected to the output node and a weight set to the link corresponding to the input nodes.

As described above, in the neural network, one or more nodes are connected to each other through one or more links to form an input node and output node relationship in the neural network. In the neural network, a characteristic of the neural network may be determined in accordance with the number of the nodes and links and a correlation between the nodes and links, and a weight assigned to the links. For example, when there are two neural networks in which the same number of nodes and links are provided and weights of links are different, it may be recognized that the two neural networks are different.

The neural network may be configured as a set of one or more nodes. A subset of the nodes that make up the neural network may form a layer. Some of the nodes which configure the neural network may configure one layer based on distances from the initially input nodes. For example, a set of nodes whose distance from the initially input node is n may configure n layers. The distance from the initially input node may be defined by a minimum number of links which need to go through to reach from the initially input node to the corresponding node. However, the definition of the layer is arbitrary provided for description and the dimensionality of the layer in the neural network may be defined differently from the above description. For example, the layer of the nodes may be defined by a distance from the finally output node.

The initially input node may refer to one or more nodes to which data is directly input without passing through the link in the relationship with other nodes, among the nodes in the neural network. Alternatively, in the neural network, in the relationship between nodes with respect to the link, the initially input node may refer to nodes which do not have other input nodes linked by the link. Similarly, the final output node may refer to one or more nodes which do not have an output node, in the relationship with other nodes, among the nodes in the neural network. Further, a hidden node may refer to nodes which configure the neural network, other than the initially input node and the finally output node. In the neural network according to an exemplary embodiment of the present disclosure, the number of nodes of the input layer may be equal to the number of nodes of the output layer and the number of nodes is reduced and then increased from the input layer to the hidden layer. Further, in the neural network according to another exemplary embodiment of the present disclosure, the number of nodes of the input layer may be smaller than the number of nodes of the output layer and the number of nodes is reduced from the input layer to the hidden layer. Further, in the neural network according to another exemplary embodiment of the present disclosure, the number of nodes of the input layer may be larger than the number of nodes of the output layer and the number of nodes is increased from the input layer to the hidden layer. The neural network according to another exemplary embodiment of the present disclosure may be a neural network obtained by the combination of the above-described neural networks.

A deep neural network (DNN) may refer to a neural network including a plurality of hidden layers in addition to the input layer and the output layer. When the deep neural network is used, latent structures of the data may be identified. That is, it is possible to identify latent structures of photos, texts, video, audio, and music (for example, which objects are in the photo, what is the content and the emotion of the text, and what is the content and the emotion of the audio). The deep neural network may include a convolutional neural network (CNN), a recurrent neural network (RNN), autoencoder, a generative adversarial network (GAN), a restricted boltzmann machine (RBM), a deep belief network (DBN), a Q network, a U network, a Siamese network, and a generative adversarial network (GAN). Description of the above-described deep neural networks is only an example and the present disclosure is not limited thereto.

According to an exemplary embodiment of the present disclosure, the network function may include an autoencoder. The autoencoder may be a sort of an artificial neural network to output output data which is similar to the input data. The autoencoder may include at least one hidden layer and an odd number of hidden layers may be disposed between input and output layers. The number of nodes in each layer may be reduced from the number of nodes of the input layer to be an intermediate layer called a bottleneck layer (encoding) and then expand from the bottleneck layer to the output layer (is symmetrical to the input layer) to be symmetrical to the reduction. The autoencoder non-linear may perform dimensionality reduction. The number of input layers and output layers may correspond to the dimensions after the pre-processing of the input data. In the autoencoder structure, the number of nodes of the hidden layer included in the encoder is reduced as the distance from the input layer increases. When the number of nodes of the bottle neck layers (a layer having the smallest number of nodes located between the encoder and a decoder) is too small, sufficient amount of information may not be transmitted. Therefore, the node may be maintained to be a certain number or more (for example, a half or more of the input layer).

The neural network may be trained by at least one of supervised learning, unsupervised learning, semi supervised learning, or reinforcement learning. Training of the neural network may be a process of applying knowledge to the neural network to perform specific actions.

The neural network may be trained to minimize an error of the output. Training data is repeatedly input to the neural network during the training of the neural network, an output of the neural network for the training data and an error of the target are calculated, and an error of the neural network is back-propagated from the output layer of the neural network to the input layer direction so as to reduce the error to update a weight of each node of the neural network. In the case of the supervised learning, training data (that is, labeled training data) labeled with a correct answer is used for each training data, but in the case of the unsupervised learning, the correct answer may not be labeled to each training data. That is, for example, the training data of the supervised learning for data classification may be training data labeled with category. The labeled training data is input to the neural network and the error may be calculated by comparing the output (category) of the neural network and the label of the training data. As another example, in the case of the unsupervised learning for data classification, an error may be calculated by comparing the training data which is an input with the neural network output. The calculated error is backpropagated to a reverse direction (that is, a direction from the output layer to the input layer) in the neural network and a connection weight of each node of each layer of the neural network may be updated in accordance with the backpropagation. A variation of the connection weight of the nodes to be updated may vary depending on a learning rate. The calculation of the neural network for the input data and the backpropagation of the error may configure a learning epoch. The learning rate may be differently applied depending on the repetitive number of the learning epochs of the neural network. For example, at the beginning of the neural network learning, the neural network quickly ensures a predetermined level of performance using a high learning rate to increase efficiency and at the late stage of the learning, the low learning rate is used to increase the precision.

In the training of the neural network, normally, the training data may be a sub set of the actual data (that is, data to be processed using the learned neural network). Therefore, there may be a learning epoch that the error of the training data is reduced and the error is increased for the actual data. The overfitting is a phenomenon in which the training data is excessively learned so that an error for real data is increased. For example, a phenomenon that a neural network that learns a cat by showing a yellow cat does not recognize a cat other than the yellow cat as a cat may be a sort of overfitting. The overfitting may act as a cause of the increase of the error of the machine learning algorithm. In order to prevent the overfitting, various optimization methods may be used. In order to prevent the overfitting, a method of increasing training data, regularization, a dropout method of inactivating some nodes of the network during the learning process, and a method of utilizing a batch normalization layer may be applied.

In the present disclosure, the term “model” refers to a machine learning-based computational entity implemented in software, hardware, or a combination thereof, designed to process input data and generate corresponding outputs based on learned parameters. A model may include, but is not limited to, various types of neural networks, statistical models, or any learning-based architectures used for inference and decision-making, e.g., neural networks, decision trees, support vector machines, and probabilistic models.

Specifically, within the context of this disclosure:

The “main model” refers to a machine learning model that undergoes training using shared labeled data and operates to perform inference on given inputs.

The “attack model” refers to a separate machine learning model trained to generate adversarial examples by analyzing the behavior of the main model.

Unless explicitly stated otherwise, the term “model” should be interpreted as encompassing both the main model and the attack model, including their respective architectures, parameters, training methodologies, and interactions within the collaborative learning framework.

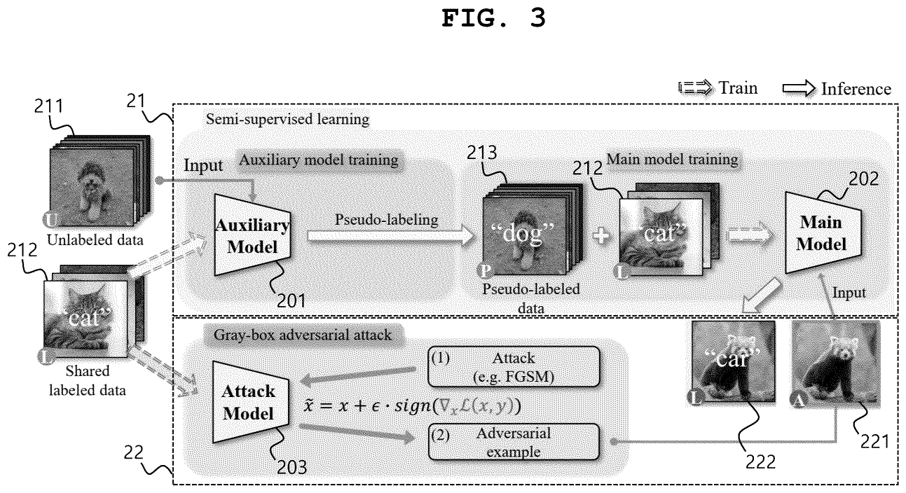

FIG. 3 is a schematic diagram showing a process of generating a main model according to an embodiment and a process of attacking the main model.

A main model generation process 21 or a main model attack process 22, shown in FIG. 3, may be performed by the foregoing computing device 100.

Below, it will be assumed that an auxiliary model 201 and a main model 202 generated by the main model generation process 21, and an attack model 203 generated by the main model attack process 22 are image classification models. However, the embodiments described below are not necessarily applicable only to the image classification model, and may also be applied to models generated by other learning methods or other types of the learning model.

First, the main model generation process 21 shown in FIG. 3 will be described. The main model generation process may be performed by the computing device 100 described above. However, according to another embodiment, the main model generation process may be performed by a device other than the foregoing computing device 100.

Referring to FIG. 3, in the main model generation process 21, an auxiliary model 201 may first be generated by auxiliary model training.

According to an embodiment, the auxiliary model 201 may be trained using shared labeled data 212. Here, the ‘shared labeled data’ 212 refers to labeled data (e.g., labeled image data) that is publicly available (e.g., data that is downloadable by anyone through a public site).

When the auxiliary model 201 is generated, pseudo-labeling may be performed on unlabeled data 211 by inputting the unlabeled data 211 to the auxiliary model 201. Here, the ‘unlabeled data’ 211 refers to data with no label (e.g., unlabeled image data). Unlike the shared labeled data 212, the unlabeled data 211 may be data that is not publicly available, i.e., non-public data.

According to an embodiment, the number (or size) of the unlabeled data 211 may be greater than the number (or size) of the shared labeled data 212.

As the auxiliary model 201 performs the pseudo-labeling for the unlabeled data 211, pseudo-labeled data 213 may be generated. The pseudo-labeled data 213 refers to data obtained by performing the pseudo-labeling for each of the unlabeled data 211.

Next, the training of the main model 202 may be performed using the pseudo-labeled data 213 and the shared labeled data 212. By this training, the learning and generation of the main model 202 may be achieved.

According to an embodiment, the number (or size) of the pseudo-labeled data 213 may be greater than the number (or size) of the shared labeled data 212.

As described above, the pseudo-labeled data 213 included in the data for training the main model 202 is generated based on the unlabeled data 211. Further, the auxiliary model 201 that performs the pseudo-labeling for the unlabeled data 211 is trained with the labeled data 212. Therefore, it may be regarded that the main model 202 is generated by the semi-supervised learning.

Next, the main model attack process 22 shown in FIG. 3 will be described. The main model attack process may be performed by the foregoing computing device 100.

Referring to FIG. 3, in the main model attack process 22, the computing device 100 may train the attack model 203 using the shared labeled data 212. Here, the shared labeled data 212 used in training the attack model 203 may be the same as the shared labeled data 212 used in training the auxiliary model 201.

According to an embodiment, a network architecture used for training the attack model 203 may be different from the network architecture used for training the main model 202. However, according to another embodiment, the network architecture used for training the attack model 203 may be the same as the network architecture used for training the main model 202.

According to an embodiment, the number (or size) of the shared labeled data 212 used in training the attack model 203 may be smaller than the number (or size) of data (the pseudo-labeled data 213 and the shared labeled data 212) used for training the main model 202 that is the target of the attack. Therefore, it may be regarded that the main model 202 is ‘fully’ trained with the pseudo-labeled data 213 and the shared labeled data 212 and the attack model 203 is ‘partially’ trained with the shared labeled data 212.

When the training of the attack model 203 using the shared labeled data 212 is completed, the computing device 100 may perform an attack on the attack model 203 to generate an adversarial example.

According to an embodiment, the computing device 100 may perform an attack on the attack model 203 by using a known attack technique, such as a fast gradient signed method (FGSM) or a projected gradient descent (PGD). However, the type of attack technique used by the computing device 100 to attack the attack model 203 is not limited thereto, and other known attack techniques may be applied.

For example, when the FGSM technique is used as illustrated in FIG. 3, the computing device 100 may generate an adversarial example (\tilde{X}) by adding the noise, (∈·sign(∇ₓ [symbol] (x, y))) to arbitrary data (x). Here, ∈ represents a constant representing the size of the noise, [symbol] represents a cost function of the attack model 203, and y represents a correct answer label corresponding to the data (x). Further, ∇ₓ [symbol] (x, y) represents the gradient of the cost function corresponding to the data (x). However, in another embodiment, the computing device 100 may also generate an adversarial example using techniques other than the FGSM.

When an adversarial example 221 is generated by an attack on the attack model 203, the computing device 100 may input the adversarial example 221 to the main model 202. Accordingly, the computing device 100 may induce the main model 202 to output an incorrect inference about the adversarial example 221. For example, when the adversarial example 221 is input, the main model 202 may output an incorrect inference (e.g., “car”) 222 from the adversarial example 221.

As is known, according to the black-box attack technique, an attacker trains a personal substitute model different from the learning model that is the target of the attack, performs a white-box attack (e.g., FGSM) on the substitute model to generate an adversarial example, and inputs the adversarial example into the learning model that is the target of the attack, thereby performing the attack. In this case, the data used in training the substitute model is different from the data used in training the learning model that is the target of the attack.

However, in the foregoing main model attack process 22, unlike the existing black box attack, the data 212 used for training the substitute model, i.e., the attack model 203 is at least partially the same as the data used for training the main model 202 that is the target of the attack. Further, in the foregoing main model attack process 22, an adversarial attack on the main model 202 is performed using an adversarial example obtained by adding noise to arbitrary data. Therefore, the foregoing main model attack process 22 may be referred to as a gray-box adversarial attack.

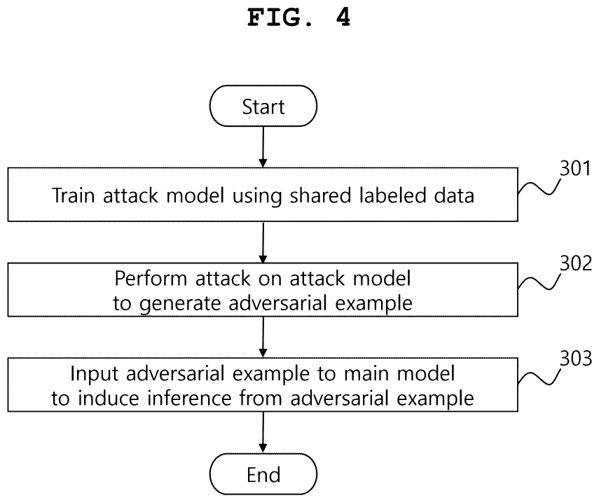

FIG. 4 is a flowchart of a method for attacking a main model according to an embodiment.

The method for attacking the main model, shown in FIG. 4, may be performed by the foregoing computing device 100.

The method for attacking the main model according to an embodiment of the present disclosure may include steps of training an attack model using shared labeled data (301), performing an attack on the attack model to generate an adversarial example (302), and inputting the adversarial example to the main model to induce an inference about the adversarial example (303).

According to an alternative embodiment, the main model may be generated by the semi-supervised learning performed using the shared labeled data.

According to an alternative embodiment, the main model may be trained using pseudo-labeled data and the shared labeled data.

According to an alternative embodiment, the number of the pseudo-labeled data may be greater than the number of the shared labeled data.

According to an alternative embodiment, the pseudo-labeled data may be generated by an auxiliary model trained using the shared labeled data.

According to an alternative embodiment, the auxiliary model may perform pseudo-labeling for the unlabeled data to generate the pseudo-labeled data.

According to an alternative embodiment, the number of the unlabeled data may be greater than the number of the shared labeled data.

The steps mentioned in the foregoing description may be further divided into additional steps or combined into fewer steps, depending on the implementation of the present disclosure. In addition, some steps may be omitted as necessary, and the order of the steps may be changed.

According to an embodiment of the present disclosure, a computer-readable medium storing a data structure will be disclosed.

The data structure may refer to the organization, management, and storage of data that enables efficient access to and modification of data. The data structure may refer to the organization of data for solving a specific problem (e.g., data search, data storage, and data modification in the shortest time). The data structures may be defined as physical or logical relationships between data elements, designed to support specific data processing functions. The logical relationship between data elements may include a connection relationship between data elements that a user defines. The physical relationship between data elements may include an actual relationship between data elements physically stored on a computer-readable storage medium (e.g., persistent storage device). The data structure may specifically include a set of data, relationships between data, and functions or commands applicable to the data. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a manner that each data is connected in a row with a pointer. In the connection list, the pointer may include connection information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data arrangement structure that may access data limitedly and unlike a stack, the queue may be a data structure (FIFO-First in First Out) in which late stored data is output late. The deck may be a data structure capable of processing data at both ends of the data structure.

The nonlinear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout the present disclosure, a computation model, the neural network, a network function, and the neural network may be used as the same meaning. Hereinafter, the computation model, the neural network, the network function, and the neural network will be integrated and described as the neural network. The data structure may include the neural network. In addition, the data structures, including the neural network, may be stored in a computer readable medium. The data structure including the neural network may include preprocessed data for processing based on the neural network, data input to the neural network, weights of the neural network, hyper parameters of the neural network, data obtained from the neural network, an active function associated with each node or layer of the neural network, a loss function for training of the neural network, etc. The data structure including the neural network may include predetermined components of the components disclosed above. That is, the data structure including the neural network may include all of preprocessed data for processing based on the neural network, data input to the neural network, weights of the neural network, hyper parameters of the neural network, data obtained from the neural network, an active function associated with each node or layer of the neural network, and a loss function for learning the neural network, or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called node. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include weights of the neural network (weights and parameters may be used as the same meaning in the present disclosure). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is merely an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Therefore, it is assumed that the above-described weights and/or combinations of respective weights are included in the data structure including the weights of the neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconstructed in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which is varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto

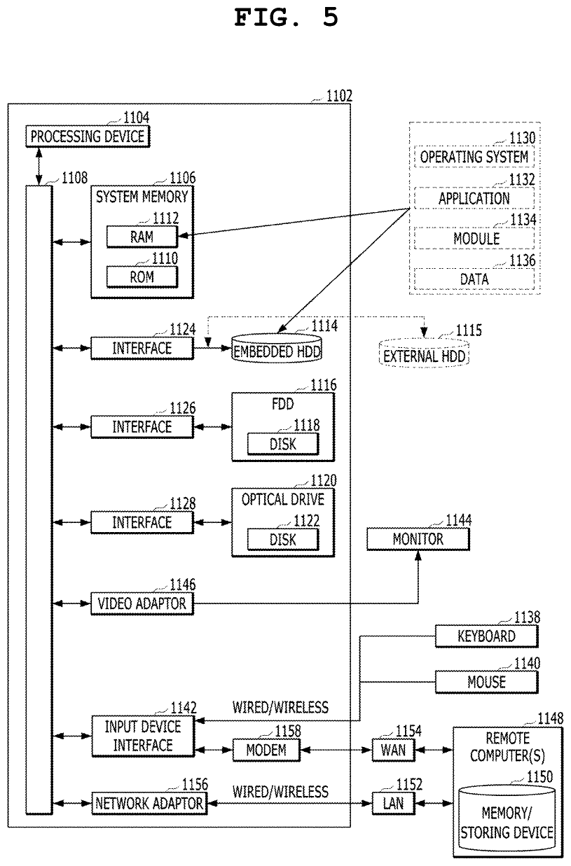

FIG. 5 is a simple and general schematic diagram for an exemplary computing environment where embodiments of the present disclosure can be implemented.

Although the present disclosure has generally been described above as being generally implementable by the computing device, it will be well appreciated by those skilled in the art that the present disclosure may be implemented through computer-executable instructions and/or a combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices), as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computer typically includes a variety of computer readable media. The computer readable media may be any available media that can be accessed by the computer and includes both volatile and nonvolatile media, transitory and non-transitory media, and movable and immovable media. By way of example, and not limitation, the computer readable media may include computer-readable storage media and computer-readable communication media. The computer-readable storage media includes volatile and nonvolatile media, transitory and non-transitory media, and movable and immovable media implemented in any method or technology for storage of information such as computer readable instructions, data structures, program modules, or other data. The computer-readable storage media includes, but is not limited to, a RAM, a ROM, an EEPROM, a flash memory, or other memory technology; a CD-ROM, digital versatile disks (DVD), or other optical disk storage; magnetic cassettes, magnetic tape, magnetic disk storage, or other magnetic storage devices; or any other medium which can be used to store the desired information and which can be accessed by the computer.

The computer-readable communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the computer-readable communication media includes wired media such as a wired network or direct-wired connection, and wireless media such as acoustic, RF, infrared, and other wireless media. Combinations of any of the above should also be included within the scope of the computer-readable communication media.

An environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device, a router, a personal computer, a portable computer, a micro-processor-based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, be connected to a communication computing device on the WAN 1154, or have other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other, to the Internet, and to the wired network k (using IEEE 802.3 or Ethernet). The Wi-Fi network may operate, for example, at a data rate of 11 Mops (802.11a) or 54 Mbps (802.11b) in unlicensed 2.4 and 5 GHz wireless bands or operate in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, electric fields or particles, optical fields or particles, or a predetermined combination thereof.

It may be appreciated by those skilled in the art that various logical blocks, modules, processors, means, circuits, and algorithm steps described in association with the embodiments disclosed herein may be implemented by electronic hardware, various types of programs or design codes (for easy description, herein, referred to as “software”), or a combination of all of them. In order to clearly describe the intercompatibility of the hardware and the software, various components, blocks, modules, circuits, and steps have been generally described above in association with functions thereof. Whether the functions are implemented as hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, an apparatus, or a standard programming and/or engineering technique. The term “manufactured article” includes a computer program, a carrier, or a medium which is accessible by a predetermined computer readable device. For example, a computer readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be analyzed within the widest range which is coherent with the principles and new features presented herein.

According to embodiments, a gray-box adversarial attack method and apparatus are proposed as a new attack technique on a learning model generated by semi-supervised learning. By training the learning model using the adversarial examples based on the new adversarial attack method, the robustness of the learning model against the adversarial attacks may be improved. Therefore, the performance, reliability, and stability of the learning model are improved simultaneously.

Although embodiments of the present disclosure have been described above with reference to the accompanying drawings, the present disclosure is not limited to the embodiments and the accompanying drawings and various modifications can be made by those skilled in the art. In addition, even though the effects of the the present disclosure are not explicitly described while describing the embodiments of the present disclosure, the effects predictable by those features should also be acknowledged.

1. A method for attacking a main model, performed by a computing device, the method comprising:
training an attack model using shared labeled data;
performing an attack on the attack model to generate an adversarial example; and
inputting the adversarial example to the main model to induce an inference about the adversarial example,
wherein the main model is generated by semi-supervised learning performed using the shared labeled data.

2. The method of claim 1, wherein the main model is trained using pseudo-labeled data and the shared labeled data.

3. The method of claim 2, wherein the number of pseudo-labeled data is greater than the number of the shared labeled data.

4. The method of claim 2, wherein the pseudo-labeled data is generated by an auxiliary model trained using the shared labeled data.

5. The method of claim 4, wherein the auxiliary model performs pseudo-labeling for unlabeled data to generate the pseudo-labeled data.

6. The method of claim 5, wherein the number of the unlabeled data is greater than the number of the shared labeled data.

7. A computing device for attacking a main mode, comprising:
at least one processor; and
a memory,
wherein the at least one processor is configured to:
train an attack model using shared labeled data;
perform an attack on the attack model to generate an adversarial example; and
input the adversarial example to the main model to induce an inference about the adversarial example,
wherein the main model is generated by semi-supervised learning performed using the shared labeled data.

8. The computing device of claim 7, wherein the main model is trained using pseudo-labeled data and the shared labeled data.

9. The computing device of claim 8, wherein the number of pseudo-labeled data is greater than the number of the shared labeled data.

10. The computing device of claim 8, wherein the pseudo-labeled data is generated by an auxiliary model trained using the shared labeled data.

11. The computing device of claim 10, wherein the auxiliary model performs pseudo-labeling for unlabeled data to generate the pseudo-labeled data.

12. The computing device of claim 11, wherein the number of the unlabeled data is greater than the number of the shared labeled data.

13. A computer program stored in a computer-readable storage medium and performing operations to train a language model upon being executed in one or more processors, the operations comprising:
training an attack model using shared labeled data;
performing an attack on the attack model to generate an adversarial example; and
inputting the adversarial example to the main model to induce an inference about the adversarial example,
wherein the main model is generated by semi-supervised learning performed using the shared labeled data.

14. The computer program of claim 13, wherein the main model is trained using pseudo-labeled data and the shared labeled data.

15. The computer program of claim 14, wherein the number of pseudo-labeled data is greater than the number of the shared labeled data.

16. The computer program of claim 14, wherein the pseudo-labeled data is generated by an auxiliary model trained using the shared labeled data.

17. The computer program of claim 16, wherein the auxiliary model performs pseudo-labeling for unlabeled data to generate the pseudo-labeled data.

18. The computer program of claim 17, wherein the number of the unlabeled data is greater than the number of the shared labeled data.
